(19) United States
(12) Patent Application Publication
(10) Pub. No.: US 2015/0378451 A1
(43) Pub. Date: Dec. 31, 2015

(54) PORTABLE SHEATH

(71) Applicant: SONGTAK TECHNOLOGY CO., LTD., TAOYUAN (TW)

(72) Inventors: MAO-SUNG WU, LUZHU TOWNSHIP (TW); CHEN-HAO CHU, TAOYUAN (TW)

(21) Appl. No.: 14/316,851

(22) Filed: Jun. 27, 2014

(51) Int. Cl. G06F 3/039

(52) U.S. Cl. CPC G06F 3/039

(57) ABSTRACT

A portable sheath is introduced. The portable sheath includes a sheath body and a cord. The sheath body includes an insertion portion. The cord is connected to the sheath body and adapted to fasten the sheath body to a data-related device. A penlike device can be inserted into the insertion portion and thus attached to the data-related device. Hence, users can carry the data-related device together with the penlike device, thereby minimizing the chance that the penlike device gets lost.

### FIELD OF THE TECHNOLOGY

The present invention relates to portable sheaths, and more particularly, to a sheath for containing a penlike device in a manner to enhance the portability thereof.

### BACKGROUND

Portable electronic devices which come with a touchscreen are in wide use and are commonly commercially available in the form of tablets, smartphones, and notebook computers. To operate a portable electronic device, users touch icons and the keys of virtual keyboards displayed on a user interface provided on the touchscreen, using their fingertips, so as to execute software and apps installed on the portable electronic device. However, the foresaid prior art has drawbacks. It is likely that a user's fingertip is bigger than an icon or the keys of a virtual keyboard on the user interface of a portable electronic device, and in consequence the user's big fingertip are unlikely to touch any intended icon or key precisely. In winter, it can be too cold for bare fingers to touch a touchscreen outdoors. Human fingers are naturally oily even when thoroughly clean, and get dirty in the course of daily life. Oil and dirt from the fingers can build up on a touchscreen. Furthermore, not everyone can user their fingers, for example, in case of moderate orthopedic disabilities in the upper limbs. To overcome the aforesaid drawbacks of the prior art, users use styluses with their portable electronic device, because styluses have advantages over human fingers in the following aspects. Unlike fingers, styluses are not only precise but also have multiple tip designs. Styluses protect the touchscreen from scratches which might otherwise be caused by long sharp fingernails. Moreover, portable touchscreen-equipped electronic device users have a higher typing speed with styluses than with fingers.

However, most conventional portable electronic devices equipped with a touchscreen neither come with a stylus nor include any structure for receiving a stylus. As a result, users have to carry a stylus in order to operate the touchscreen by means of the stylus. Furthermore, conventional styluses are so small that users are likely to forget to bring a stylus or lose it. For the above reasons, the prior art brings inconvenience to the users.

### SUMMARY

In view of the aforesaid drawbacks of the prior art, it is an objective of the present invention to allow a stylus to be fastened to a portable electronic device equipped with a touchscreen such that users can carry the portable electronic device together with the stylus conveniently.

In order to achieve the above and other objectives, the present invention provides a portable sheath, comprising: a sheath body including an insertion portion; and a cord connected to the sheath body and adapted to fasten the sheath body to a data-related device.

Regarding the portable sheath in an embodiment of the present invention, the sheath body includes a soft outer layer and a support layer coupled to the soft outer layer.

Regarding the portable sheath in an embodiment of the present invention, the support layer is provided in form of one of a cardboard and a metal sheet.

Regarding the portable sheath in an embodiment of the present invention, a cleaning layer is disposed on the sheath body.

Regarding the portable sheath in an embodiment of the present invention, the cleaning layer is provided in form of a wiping fabric made of a flannel.

Regarding the portable sheath in an embodiment of the present invention, the insertion portion of the sheath body is pouch-shaped and has a closed bottom end.

Regarding the portable sheath in an embodiment of the present invention, the cord is elastic.

Regarding the portable sheath in an embodiment of the present invention, the sheath body and the cord are coupled together by means of machine sewing.

Regarding the portable sheath in an embodiment of the present invention, the sheath body and the cord are integrally formed as a unitary structure.

According to an embodiment of the present invention, a portable sheath comprises a sheath body into which a stylus can be inserted and thus contained therein. The portable sheath further comprises a cord which can be fastened to a data-related device, such that the stylus can be attached to the data-related device, thereby allowing a user to carry the data-related device together with the stylus conveniently.

### BRIEF DESCRIPTION OF THE DRAWINGS

Objectives, features, and advantages of the present invention are hereunder illustrated with specific embodiments in conjunction with the accompanying drawings, in which:

FIG. 1 is a schematic perspective view of a portable sheath and a penlike device according to an embodiment of the present invention;

FIG. 2 is a schematic perspective view of the portable sheath and the penlike device disposed at the portable sheath according to an embodiment of the present invention;

FIG. 3 is a schematic cross-sectional view of the sheath body according to an embodiment of the present invention;

FIG. 4 is a schematic view that illustrates how the portable sheath is applied in a smartphone according to an embodiment of the present invention;

FIG. 5 is a schematic view that illustrates how the portable sheath is applied in a tablet according to an embodiment of the present invention; and

FIG. 6 is a schematic view that illustrates how the portable sheath is applied in a tablet provided with a protective cover according to an embodiment of the present invention.

### DETAILED DESCRIPTION OF THE PREFERRED EMBODIMENTS

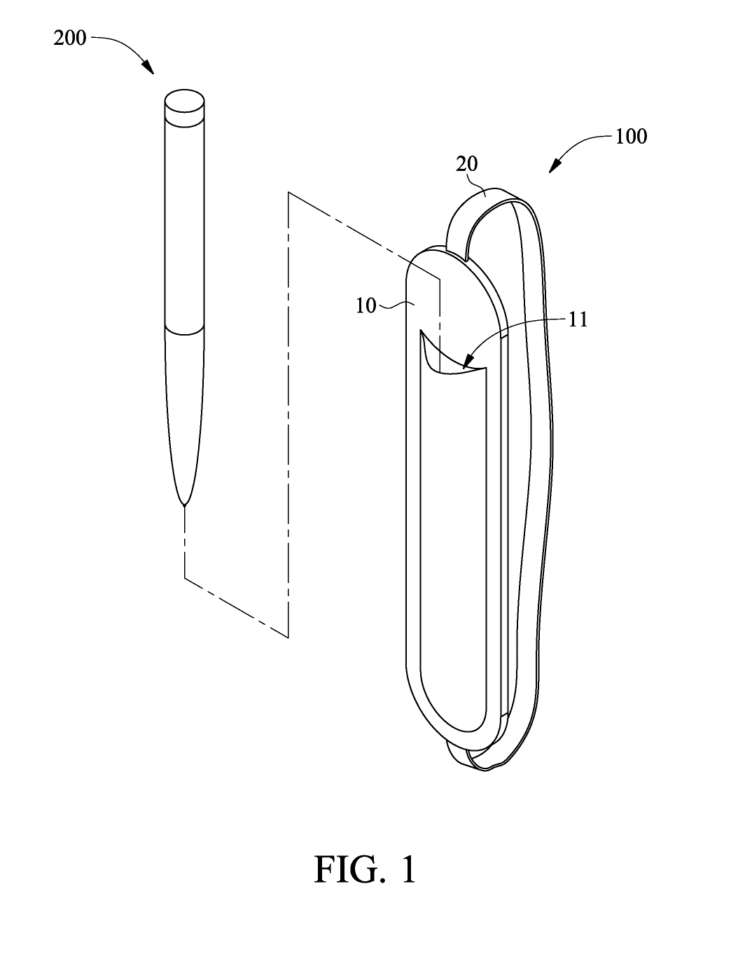

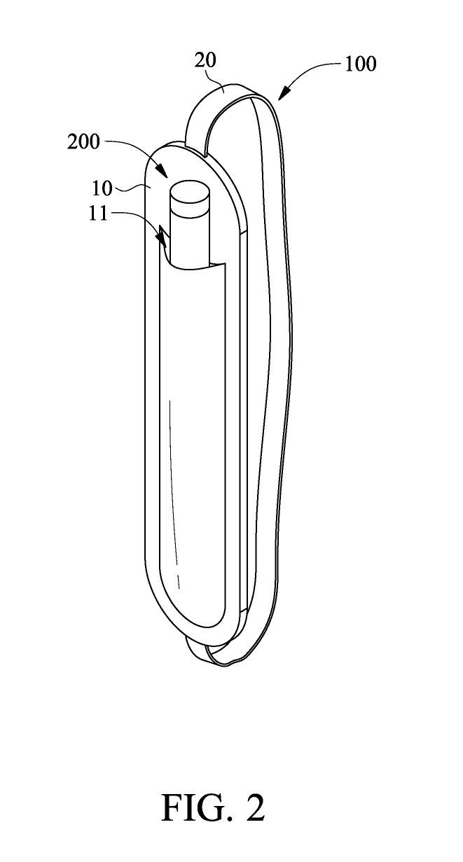

Referring to FIG. 1 and FIG. 2, in an embodiment of the present invention, the portable sheath 100 comprises a sheath body 10 and a cord 20. The portable sheath 100 is intended to be mounted on a data-related device (provided in the form of a portable electronic device equipped with a touchscreen, for example, in practice). An insertion portion 11 is disposed on one side of the sheath body 10, wherein the side of the sheath body 10 faces away from the data-related device. A penlike device 200 can be inserted into the insertion portion 11. In this embodiment, the insertion portion 11 is pouch-shaped and has a closed bottom end. The closed bottom end of the insertion portion 11 stops further advance of the penlike device 200. The cord 20 is connected to the two ends of the sheath body 10 and adapted to fasten the sheath body 10 to the data-related device. In this embodiment, the sheath body 10 and the cord 20 are coupled together by means of machine sewing. As shown in the diagrams, the sheath body 10 and the cord 20 together form a loop which winds around the data-related device. Moreover, the sheath body 10 and the cord 20 are not coupled together by means of machine sewing but are integrally formed as a unitary structure.

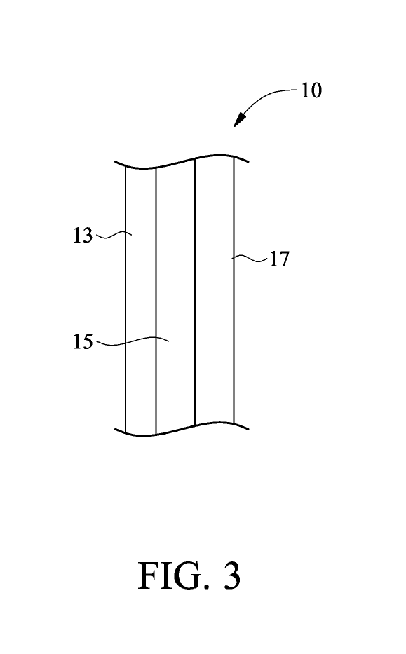

Referring to FIG. 3, in an embodiment of the present invention, the sheath body 10 of the portable sheath 100 comprises a soft outer layer 13, a cleaning layer 17, a support layer 15 sandwiched between the soft outer layer 13 and the cleaning layer 17; and, in a variant embodiment of the present invention, another cleaning layer (not shown) is further disposed on an exposed surface (i.e., the opposing surface) of the soft outer layer 13. In another embodiment of the present invention, the sheath body 10 comprises two soft outer layers (not shown) and a support layer (not shown) disposed between the two soft outer layers, wherein all the outer edges the two soft outer layers are coupled together such that the support layer is enclosed by the two soft outer layers.

In practice, the support layer 15 is provided in the form of a support board, such as a cardboard or a metal sheet, and adapted to reinforce the sheath body 10 and thus render the sheath body 10 rigid and non-deformable.

In practice, the cleaning layer 17 is provided in the form of a wiping fabric made of a flannel, and adapted to wipe dust and fingerprints from the touchscreen of the data-related device.

Hence, according to the present invention, the portable sheath 100 contains the penlike device 200 and is fastened to the data-related device, such that users are less likely to lose the penlike device 200 or forget to bring the penlike device 200.

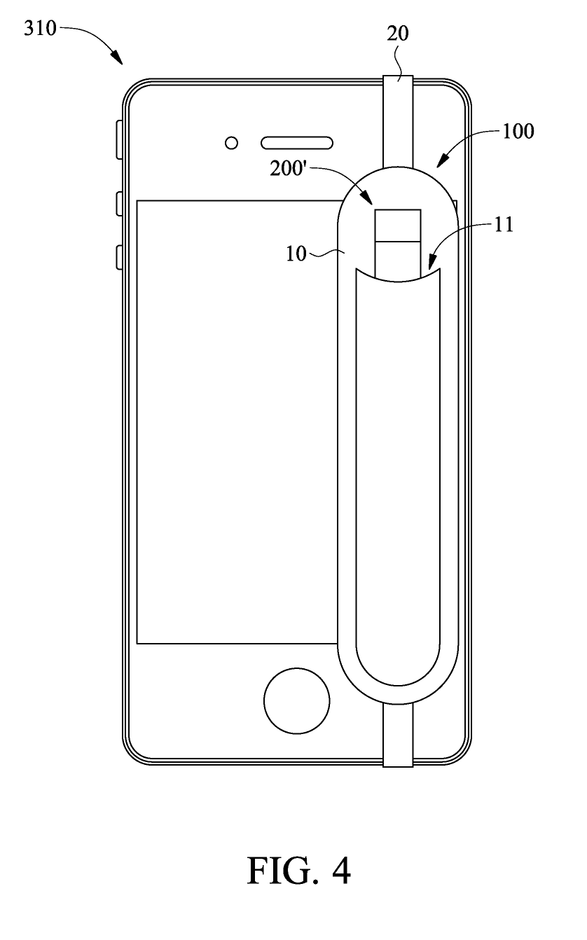

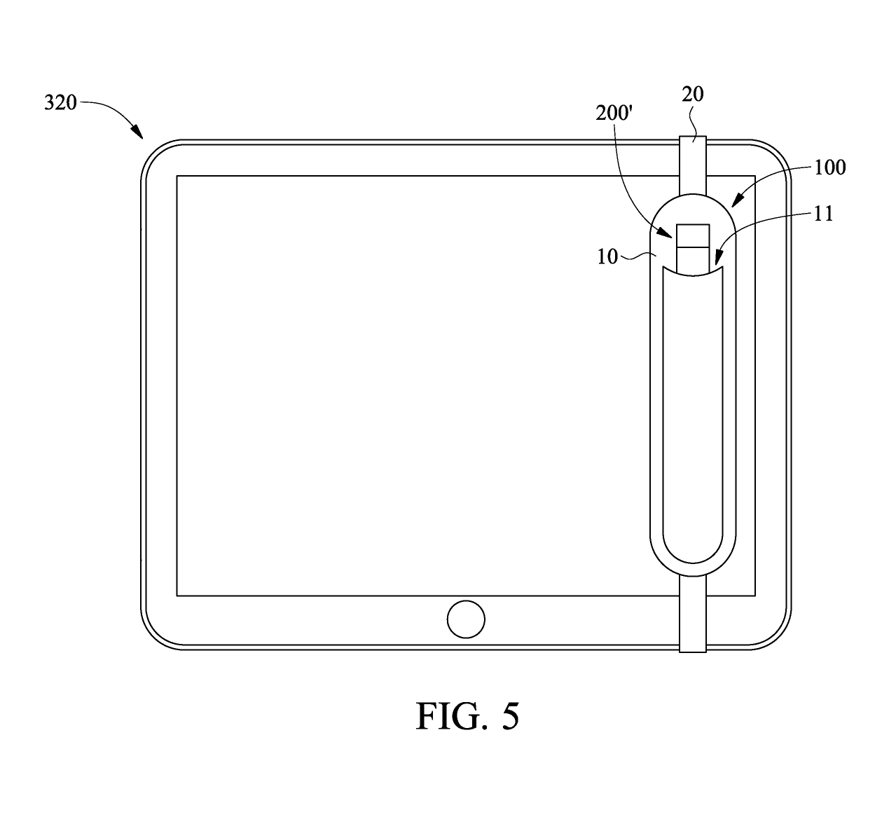

For illustrative sake, in an embodiment of the present invention, the data-related device is a smartphone 310 (shown in FIG. 4) and a tablet 320 (shown in FIG. 5), whereas the penlike device 200 is a stylus 200′ (shown in FIG. 4 through FIG. 6), but the present invention is not limited thereto, as the data-related device can also come in the form of a notepad or a calendar, whereas the penlike device 200 can also come in the form of a ballpen or a pencil.

Referring to FIG. 4 and FIG. 5, the stylus 200′ is inserted into the portable sheath 100, and the cord 20 of the portable sheath 100 is elastic and fastened to the smartphone 310 and the tablet 320, respectively. Hence, the stylus 200′ is attached to the smartphone 310 and the tablet 320, respectively, thereby minimizing the chance that users lose the stylus 200′ or forget to carry the stylus 200′.

Preferably, the stylus 200′ is retractable (not shown) to allow the users to determine whether to extend or retract, and by what extent, the stylus 200′ according to the user's handwriting gesture preferences. The retractable stylus 200′ has the following advantages: the stylus 200′ comes with one size (and particularly, one length) only and is for use with the portable sheath 100 which also comes with one size (and particularly, one length) only; and, as the stylus 200′ will still be applicable to the smartphone 310 even if the smartphone 310 has a shorter length than the maximum length of the stylus 200′, because the stylus 200′ is retractable and thus can be refracted before being mounted on the short smartphone 310. To sum up its advantages, the stylus 200′, which comes with one size (and particularly, one length) only, is applicable all data-related devices regardless of their size (and particularly, one length).

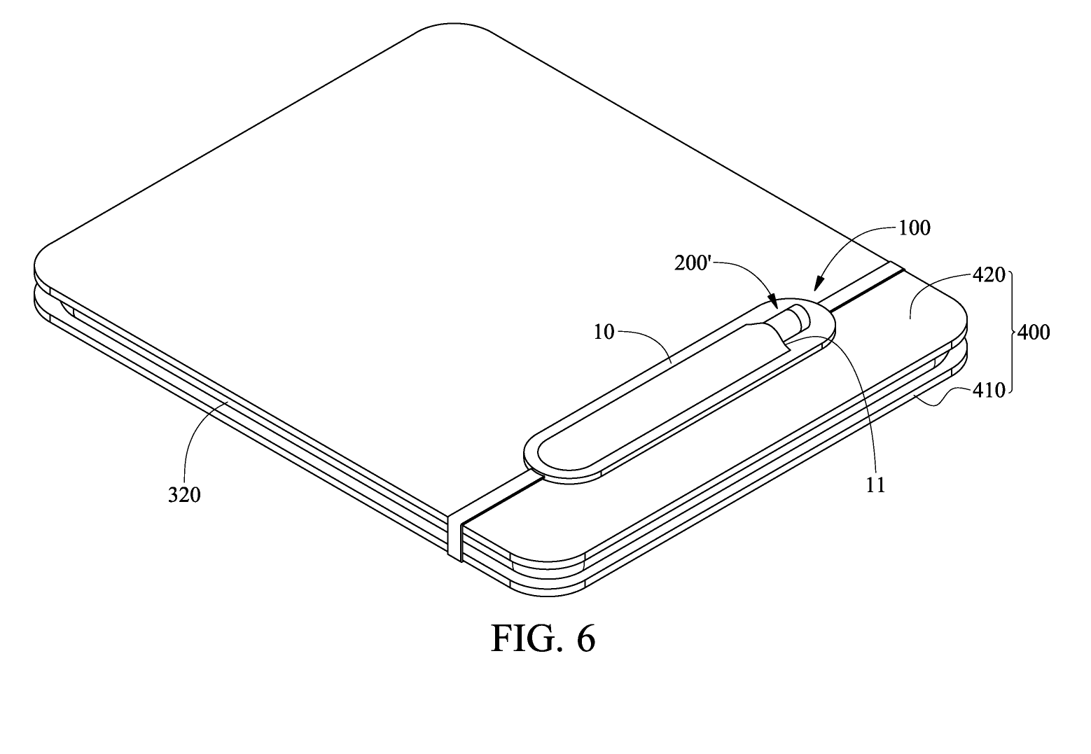

Referring to FIG. 6, the tablet 320 is disposed inside a protective sleeve 400. The protective sleeve 400 comprises a base 410 and a protective cover 420. One side of the tablet 320 is in contact with and thus is protected by the base 410. The opposing side of the tablet 320 is in contact with and thus is protected by the protective cover 420. When the tablet 320 is not in use but is held inside the protective sleeve 400, the cord 20 of the portable sheath 100 is fastened to the base 410 and the protective cover 420 to thereby prevent the protective cover 420 from being inadvertently lifted off the base 410.

In conclusion, according to an embodiment of the present invention, a portable sheath comprises a sheath body into which a stylus can be inserted and thus contained therein. The portable sheath further comprises a cord which can be fastened to a data-related device, such that the stylus can be attached to the data-related device, thereby allowing a user to carry the data-related device together with the stylus conveniently.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A portable sheath, comprising:
a sheath body including an insertion portion; and
a cord connected to the sheath body and adapted to fasten the sheath body to a data-related device.

2. The portable sheath of claim 1, wherein the sheath body includes a soft outer layer and a support layer coupled to the soft outer layer.

3. The portable sheath of claim 2, wherein the support layer is provided in form of one of a cardboard and a metal sheet.

4. The portable sheath of claim 1, wherein a cleaning layer is disposed on the sheath body.

5. The portable sheath of claim 4, wherein the cleaning layer is provided in form of a wiping fabric made of a flannel.

6. The portable sheath of claim 1, wherein an insertion portion of the sheath body is pouch-shaped and has a closed bottom end.

7. The portable sheath of claim 1, wherein the cord is elastic.

8. The portable sheath of claim 1, wherein the sheath body and the cord are coupled together by means of machine sewing.

9. The portable sheath of claim 1, wherein the sheath body and the cord are integrally formed.
